(19) United States
(12) Patent Application Publication
(10) Pub. No.: US 2003/0135950 A1
(43) Pub. Date: Jul. 24, 2003

(54) Roller frame handle connection to extension pole

(76) Inventor: Michael J. Dove, Mission Viejo, CA (US)

Correspondence Address: Michael J. Dove, 24115 Lindley Street, Mission Viejo, CA, 92691, US

(21) Appl. No.: 10/050,172

(22) Filed: Jan. 18, 2002

(51) Int. Cl. B05C 17/02; B25G 3/02

(52) U.S. Cl. 15/230.11; 15/145; 492/13; 492/19; 16/427

(57) ABSTRACT

A roller frame handle including an external diameter such size as to allow connection into the internal diameter of a receiving extension pole. The connection locking into position by a spring button device. The roller frame handle forming the inner portion of the connection and the receiving extension pole forming the outer portion of the connection.

### BACKGROUND OF THE INVENTION

1. Field of the Invention

The present invention relates to a roller handle that can quickly and efficiently be connected to an extension pole.

The present invention relates to a combination of a paint roller handle and an extension pole therefore that is designed to prevent the paint roller handle from coming loose from the extension pole.

When painting a large area one finds convenience in using a roller assembly rather than the use of a paint brush. Roller assemblies include a cylindrical absorptive covering connected to a wire frame or the like, mounted at one end to an arm attached to a handle. The absorptive roller rotates on a cylinder to spread liquid material on a specified surface. Each time the absorptive roller covering is dipped into a liquid material and applied to the desired surface in an upward and downward movement, the liquid material is spread evenly to a wide area with speed. When high and hard to reach areas are present the spreading of the liquid material is limited to the physical reach of the person applying the material, granted by the height of the ladder, or length of the extension pole available. The use of an extension pole saves time and reduces the risk of falling off high ladders.

The extension poles that are common today are joined to the roller frame with a threaded connection. The roller frame handle has an interior threaded throat which is attached to an extension pole having an exterior threaded neck. Joining these two can be messy and time consuming.

Additionally, as sighted in U.S. Pat. No. 5,226,198 Martin Jul. 13, 1993, it is stated that:

“Conventional paint rollers have internally threaded handles so as to be capable of mounting on a cooperatively threaded extension pole. One of the problems with current configurations is that the roller assembly tends to come loose on the extension pole, which is obviously undesirable.”

So in addition to the wasted time screwing and un-screwing to form the connection, the threaded union loosens and requires continuous manipulation. Each of these detriments decrease efficiency and lengthens job completion.

### SUMMARY OF THE INVENTION

It is an object of the present invention to provide a combination of a paint roller handle assembly and an extension pole connection therefore that is designed to, provide an efficient means of connecting roller handle to extension pole, and to prevent the roller assembly from coming loose from the pole during painting operations.

This invention achieves this objective by providing a paint roller handle that connects to an extension pole as it slips into the interior diameter of the extension pole and held into position by a locking mechanism. Thus engaged, this connection disallows loosening prevalent with threaded connections commonly found in the market today.

### BRIEF DESCRIPTION OF THE DRAWINGS

FIG. 1 is an exploded perspective view of the roller extension pole of the present invention, an exploded view of the roller handle of the present invention, and a conventional roller assembly;

FIG. 1A shows the handle portion of the roller assembly

FIG. 1B is the push-button locking device projection from the handle

FIG. 1C shows the upper portion of the extension pole, the diameter is larger than that of the roller handle and the roller handle is inserted into the inside of the extension pole and locks into position

FIG. 1D is the opening in the tube that will receive the locking push-button

FIG. 1E are tabs on the roller handle to rest roller on the edge of the paint bucket

FIG. 2 is a cross-sectional view of the roller extension pole of the present invention, a cross-sectional view of the roller handle of the present invention, and a conventional roller assembly;

FIG. 2A shows cross-sectional view of the handle portion of the roller assembly

FIG. 2B is a cross-sectional view of the push-button locking device projection from the handle

FIG. 2C shows a cross-sectional view of the upper portion of the extension pole, the diameter is larger than that of the roller handle and the roller handle is inserted into the inside of the extension pole and locks into position

FIG. 2D is across-sectional view of the opening in the tube that will receive the locking push-button

FIG. 2E are tabs on the roller handle to rest roller on the edge of the paint bucket

FIG. 3 is an exploded perspective view of an additional embodiment of the roller extension pole of the present invention, a perspective view of the roller handle of the present invention, and a conventional roller assembly;

FIG. 3A shows the handle portion of the roller assembly

FIG. 3B is the push-button locking device projection from the handle

FIG. 3C shows the upper portion of the extension pole, the diameter is smaller than that of the roller handle and locks into position when inserted to the inside of the roller handle

FIG. 3D is the opening in the tube that will receive the locking push-button

FIG. 3E are tabs on the roller handle to rest roller on the edge of the paint bucket

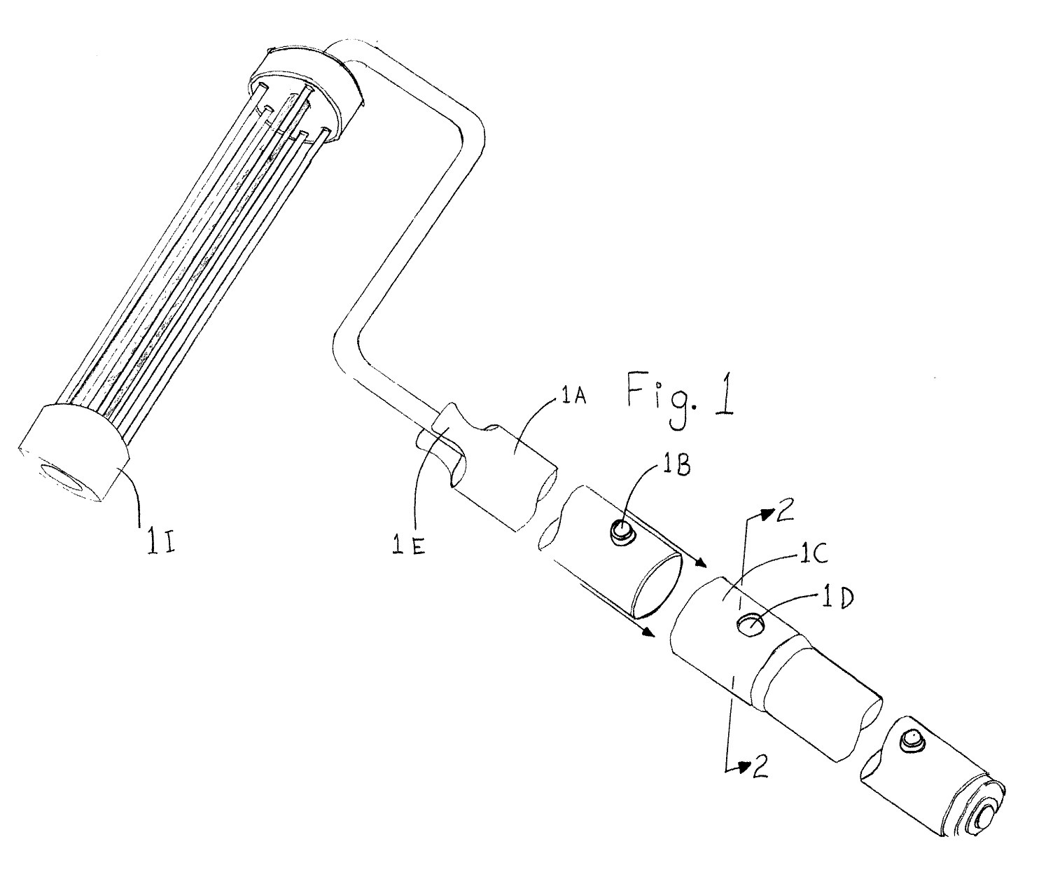

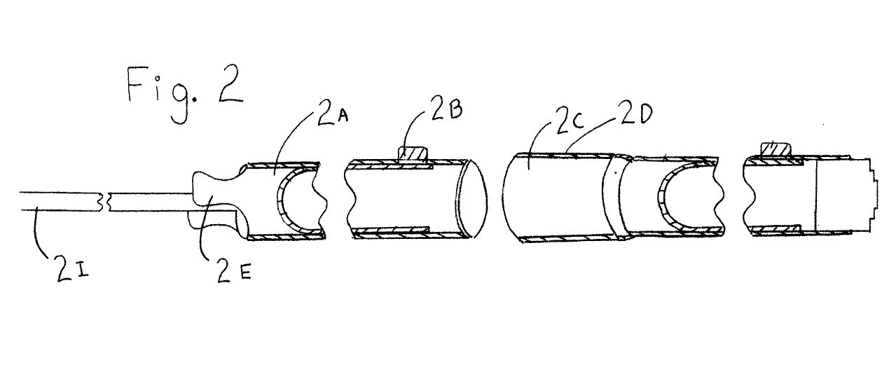

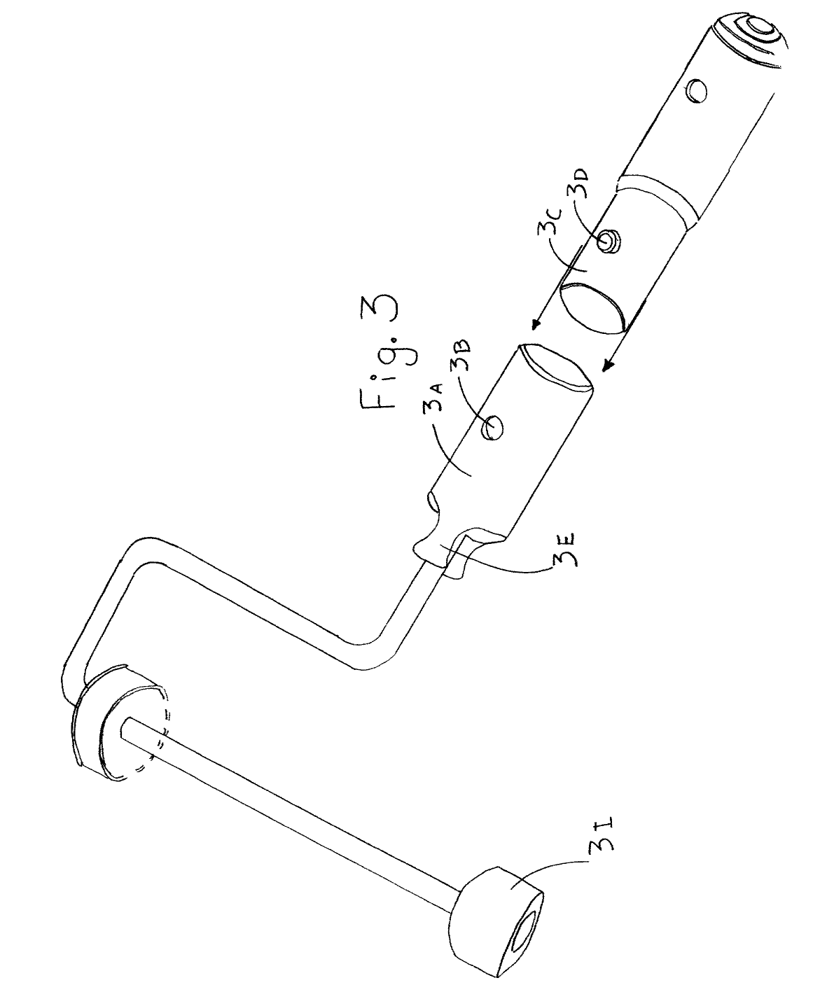

It will be understood that other modifications in the form of the invention described herein and its preferred embodiments may be made without departing from the spirit thereof and of the scope of the claims which follow.

I claim:

1. In combination, a paint roller handle assembly and extension pole connection therefore;
said paint roller handle assembly comprising:
an elongated hollow tube body having a lower end and an upper end;
upper end of said elongated hollow tube body having an arm attached which positions a cylindrical frame roller assembly;
lower end of said elongated hollow tube body having an exterior diameter smaller than that of the connecting extension pole;
lower end of said elongated hollow tube body having an opening in an exterior surface;
the opening in the exterior surface having a locking spring push button projecting from said opening.

2. An extension pole therefore comprising:
an elongated tubular member having a top-most portion adjacent to lower end of said elongated tube body;
top-most portion of said tubular member having a larger diameter than the diameter of the said lower portion of the said hollow body handle;
top-most portion of said tubular member having an opening in the exterior surface

3. Means operatively arranged between said base portion of roller handle and said top-most portion of tubular member, to fix said base portion to said tubular member;
to fix said base portion to said tubular member by a mechanical means, whereby locking together said base portion of roller handle to said tubular member.
